(19) United States
(12) Patent Application Publication
(10) Pub. No.: US 2016/0290367 A1
(43) Pub. Date: Oct. 6, 2016

(54) HYDRAULIC LOAD SENSING SYSTEM

(71) Applicant: VOLVO CONSTRUCTION EQUIPMENT AB, Eskilstuna (SE)

(72) Inventors: Johan LILLEMETS, Eskilstuna (SE); Patrik STENER, Eskilstuna (SE)

(73) Assignee: VOLVO CONSTRUCTION EQUIPMENT AB, Eskilstuna (SE)

(21) Appl. No.: 15/037,069

(22) PCT Filed: Dec. 19, 2013
(86) PCT No.: PCT/SE2013/000197

§ 371 Date: May 17, 2016

(51) Int. Cl. F15B 11/08; F15B 1/04

(52) U.S. Cl. CPC F15B 11/08; F15B 1/04

(57) ABSTRACT

A hydraulic load sensing system for a working machine includes a pomp for providing hydraulic fluid for driving an actuator, and a hydraulic accumulator. The hydraulic accumulator is arranged to provide a hydraulic fluid pressure for generating an LS-signal for controlling the hydraulic fluid pressure delivered by the pump.

### BACKGROUND AND SUMMARY

The invention relates to a hydraulic. load sensing system for a working machine, which system comprises a pump for providing hydraulic fluid for driving an actuator, and a hydraulic accumulator. The invention also relates to a method for controlling a hydraulic load sensing system.

The invention can be applied on different types of hydraulic system, in particular hydraulic steering systems for articulated frame-steered working machines such as wheel loaders and articulated haulers.

Although the invention will be described with respect to a steering system for a wheel loader, the application of the invention is riot restricted to this particular application, but may also be used in other hydraulic systems and vehicles.

A working machine is usually provided with a bucket, container or other type of implement for digging, lifting, carrying and/or transporting a load.

For example, a wheel loader has a lift arm unit for raising and lowering an implement, such as a bucket. The lift arm unit comprises a number of hydraulic cylinders for movement of a load arm and the implement attached to the load arm. A pair of hydraulic cylinders is arranged for raising the load arm and a further hydraulic cylinder is arranged for tilting the implement relative to the load arm.

In addition, the working machine is often articulated frame-steered and has a pair of hydraulic cylinders tor turning/steering the working machine by pivoting a front section and a rear section of the working machine relative to each other.

The hydraulic system generally further comprises at least one hydraulic pump, which is arranged to supply hydraulic power, i.e. hydraulic flow and/or hydraulic pressure, to the hydraulic cylinders. The hydraulic pump is driven by a power source, such as an internal combustion engine or an electric motor. The hydraulic system of a working machine is usually a so called load sensing system (LS-system). This means that the pump that provides the hydraulic system with hydraulic fluid receives a signal representing the current load pressure of a hydraulic cylinder in operation. The pump is then controlled to provide a pressure which is somewhat higher than the load pressure of the hydraulic cylinder.

The hydraulic pump is often a variable displacement pump that is driven by the prime mover of the working machine. The pump is driven via a power take-off which can be located between the internal combustion engine and a transmission arrangement, such as a gear box. The transmission arrangement is in turn connected to e.g. wheels of the work machine for the propulsion thereof.

In such a hydraulic system, energy is lost due to the fact that the pump is always turning when the engine is turning even if no pump work is needed by the hydraulic cylinders.

It is desirable to provide a hydraulic load sensing system, by which system the energy losses can be reduced at the same time as the provision of hydraulic fluid to the actuator can be secured.

The invention is based, according to an aspect thereof, on the insight that by the provision of an accumulator for generating a load sensing signal it is possible to provide the pump with a separate driving source and allow the pump to stand still if no pump work is requested. If a movement of the actuator is requested when the pump is not turning, there is always a hydraulic pressure available from the accumulator for generating an LS signal and immediately starting the pump and creating a pump pressure for providing hydraulic fluid to the actuator. The energy losses will be reduced due to the fact that the pump must not be driven when not used.

For example, in a hydraulic load sensing system a hydraulic pump driven by an electric motor can be used for supplying hydraulic fluid to a hydraulic steering system. The pump can have a fixed displacement, since the speed of the electric motor can be varied to achieve the desired flow of hydraulic fluid from the pump. The electric, motor and the pump can stand still to save energy when steering is not requested. When steering is requested, it is possible to get a quick response by means of the accumulator providing a hydraulic fluid pressure that generates an LS-signal to be transmitted to the control unit of the electric motor/pump. As soon as the load pressure of the steering system exceeds the pressure provided by the accumulator, the LS signal transmitted to the pump is however conventionally generated by the load pressure of the steering system to achieve the desired hydraulic fluid pressure to be delivered by the pump.

According to a further aspect, the invention relates to a method for controlling a hydraulic load sensing system. The same advantages as discussed above with reference to the hydraulic load sensing system can be reached by the method according to the invention.

According to one embodiment, the method comprises the step of using the LS-signal generated by the accumulator pressure, for activating the pump and starting provide hydraulic fluid to the actuator by means of the pump. By using the LS-signal created by the accumulator pressure for activating the pump and starting provide hydraulic fluid to the actuator by means of the pump, the delay time can be kept relatively short even if the pump is not running when an operation of the actuator is requested by an operator.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a lateral view illustrating a wheel loader having a hydraulic system according to the invention,

FIG. 2 shows one embodiment of the hydraulic load sensing system according to the invention,

FIG. 3 shows a further embodiment of the hydraulic load sensing system according to the invention, and

FIG. 4 is a flowchart of one embodiment of the method according to the invention,

### DETAILED DESCRIPTION

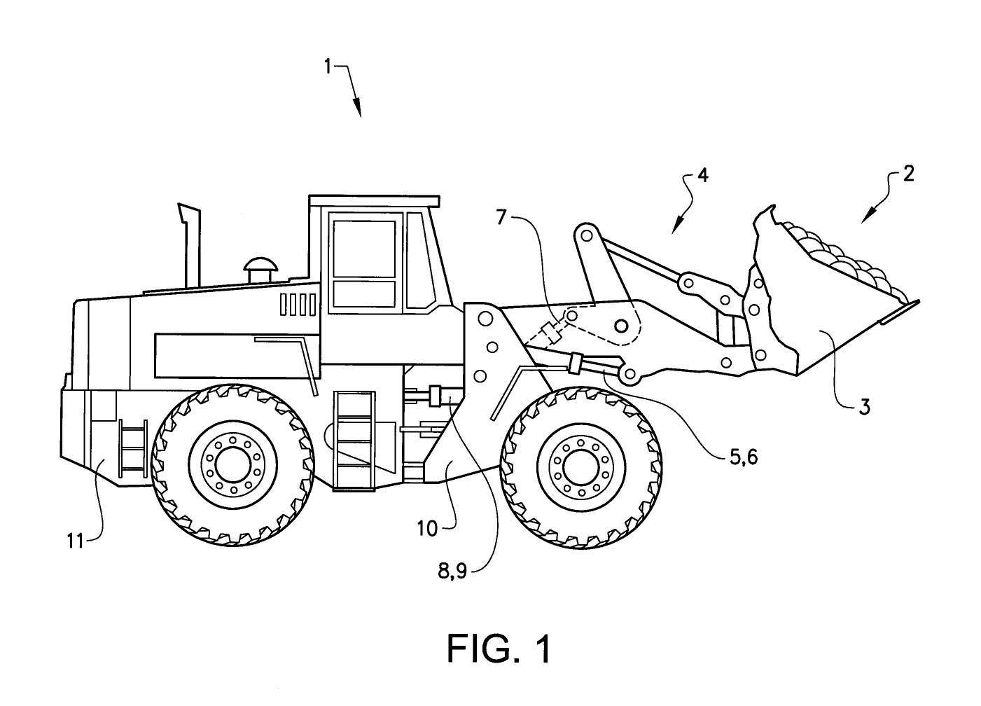

FIG. 1 is an illustration of a working machine 1 in the form of a wheel loader. The wheel loader is an example of a working machine where a hydraulic load sensing system according to the invention can be applied.

The wheel loader has an implement 2. The term “implement” is intended to comprise any kind of tool controlled by hydraulics, such as a bucket, a fork or a gripping tool. The implement illustrated is a bucket 3 which is arranged on a load arm 4 for lifting and lowering the bucket 3, and further the bucket can be tilted relative to the load arm. In the example embodiment illustrated in FIG. 1 a hydraulic system of the wheel loader comprises two hydraulic cylinders 5, 6 for the operation of the load arm 4 and a hydraulic cylinder 7 for tilting the bucket 3 relative to the load arm 4.

The hydraulic system of the wheel loader further comprises two hydraulic cylinders 8, 9, steering cylinders, arranged on opposite sides of the wheel loader 1 for turning the wheel loader by means of relative movement of a front body part 10 and a rear body part 11.

In other words; the wheel loader is articulated frame-steered by means of the steering cylinders 8, 9. There is a pivot joint connecting the front body part 10 and the rear body part 11 of the wheel loader 1 such that these parts are pivotally connected to each other for pivoting about a substantially vertical axis.

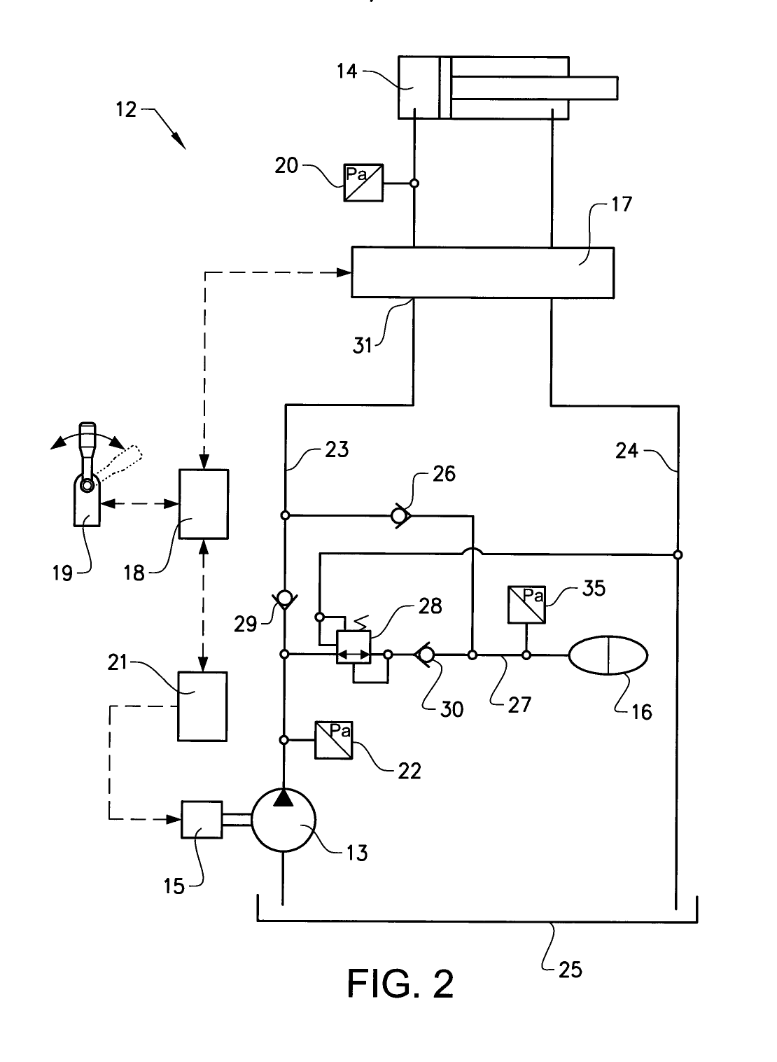

One example embodiment of the hydraulic load sensing system according to the invention is illustrated in FIG. 2. The hydraulic system 12 comprises a pump 13 for providing hydraulic fluid for driving an actuator 14. The pump 13 is driven by an electric motor 15. The actuator 14 can be one or more hydraulic cylinders or any other hydraulic, equipment.

The hydraulic system further comprises a hydraulic accumulator 16. The hydraulic. accumulator 16 can be charged with pressurized hydraulic fluid. The hydraulic accumulator 16 is arranged to provide a hydraulic fluid pressure for generating an LS-signal for controlling the hydraulic fluid pressure delivered by the pump 13.

As schematically illustrated, the hydraulic system comprises a control valve 17 for controlling the actuator 14. The hydraulic system is preferably arranged to receive signals from a control unit 18. The control unit 18 is also connected to some kind of operator input means, such as an operator lever 19. As a response to an operator request the control unit 18 controls the control valve 17 and the control valve is opened to provide hydraulic fluid from the pump 13 to the actuator 14. The hydraulic system further comprises a pressure sensor 20 for measuring the load pressure used for the LS-signal. A signal corresponding to the pressure measured by the pressure sensor 20 is transmitted to the control unit 18 and the LS-signal is transmitted from the control unit 18 to the electric motor 15 driving, the pump and/or to the pump 13. This can be performed by means of an electric machine control unit 21. The electric machine control unit 21 can be a part of the main control unit 18 or a separate unit that communicates with the main control unit 18. The control of the electric, motor 15 and the pump 13 can comprise start and stop of the electric motor, the speed and/or torque of the electric motor and adjustment of the displacement of the pump if a pump having a variable displacement is used. In the example embodiment illustrated in FIG. 2, the pump has however a fixed displacement Although the pump illustrated is of the type having a fixed displacement (since the capacity of the pump can be controlled by means of the speed of the electric motor), another pump having a variable displacement could also be used.

Normally when the actuator 14 is active and the pump 13 provides hydraulic fluid to the actuator, the pump 13 will provide a hydraulic fluid pressure corresponding to the load pressure of the actuator 14 plus an offset, such as for example the load pressure plus 20 bar. That means there is a pressure drop over the control valve 17. The pump pressure is preferably measured by a pressure sensor 22 arranged at the pump 13.

If however the pump 13 has been turned off and is not driven (and the actuator is not active) there is no load pressure. Even if the control valve 17 then is opened to activate the actuator 14, in response to an operator request, there is initially no (or a very low) load pressure in the actuator 14. This in turn means that no (relevant) LS-signal can be generated by a load pressure of the actuator and the pump will not be activated or the time period from the point of time when the operation of the actuator is requested to the point of time when the pump provides hydraulic fluid at the requisite pressure will be too long.

This problem is however overcome when using a hydraulic system according to the invention, since the accumulator 16, which preferably is fluidly connected to the actuator 14 via the control valve 17 in the same way as the pump 13, provides a hydraulic fluid pressure for generating the LS-signal. The accumulator 16 can be connected to the same inlet port 31 of the control valve 17 as the pump 13. As soon as the control valve 17 is opened the fluid pressure from the accumulator can be utilized. The pump 13 can then at least initially be controlled on the basis of the pressure generated by the hydraulic accumulator 16. By the LS-signal generated by the pressure from the accumulator 16 the motor 15 and the pump 13 are activated and the pump 13 will provide a hydraulic, fluid pressure corresponding to the LS pressure plus an offset.

In addition, the hydraulic accumulator 16 can also be arranged to provide hydraulic fluid to the actuator 14 for driving the actuator (provided that the accumulator pressure is sufficient), at least initially when the pump 13 is being started and not yet can deliver the pressure required for the operation of the actuator 14. Hydraulic fluid from the accumulator 16 can be used until the pump pressure has reached a pressure exceeding the accumulator pressure. Thereby any delay time due to the start of the pump 13 can be further reduced and the response will be even faster. In this connection, the pump 13 and the accumulator 16 can be fluidly connected to the same inlet port 31 of the control valve 17 for providing hydraulic fluid to the actuator 14.

As further appears from FIG. 2 the hydraulic system can comprise a supply line 23 extending from the pump 13 to the control valve 17 and further to the actuator 14 for supplying hydraulic fluid to the actuator 14. The hydraulic system can further comprise a 30 drain line 24 extending from the actuator 14 to the control valve 17 and further to tank 25 for draining the actuator 14. The accumulator 16 can he connected to the supply line 23, and preferably the accumulator 16 is connected via a check valve 26 to allow hydraulic fluid to flow in the direction from the hydraulic accumulator 16 to the actuator 14, but not in the opposite direction.

Furthermore, the hydraulic accumulator 16 can be fluidly connected to the pump 13 for loading the accumulator 16 when the pump 13 is driven and provides a pressure higher than the pressure in the accumulator 16. A connection line 27 between the pump 13 and the hydraulic accumulator 16 has suitably a pressure reducer valve 28 allowing the hydraulic accumulator 16 to be loaded up to a predetermined maximal hydraulic accumulator pressure. Thereby the hydraulic accumulator 16 can be continuously loaded when the pump 13 is driven, i.e. during operation of the actuator 14. A pressure sensor 35 is preferably arranged at the hydraulic accumulator 16 to measure the pressure in the accumulator 16. If the pressure in the hydraulic accumulator 16 drops below a threshold value, the pump 13 is controlled to load the accumulator and increase the pressure. Thereby it can be secured that the pressure in the hydraulic accumulator will not be lower than a predetermined, minimum hydraulic accumulator pressure.

In addition, one or more further check valves 29, 30 are preferably arranged to prevent hydraulic fluid from flowing in direction from the accumulator 16 to the pump 13 or from the actuator to the pump. The maximal pressure of the accumulator can preferably be in the size of approximately 10-50% of the normal working pressure of the pump or the maximal pump pressure. As an example only, the pressure of the hydraulic fluid of the accumulator can be 30-50 bar.

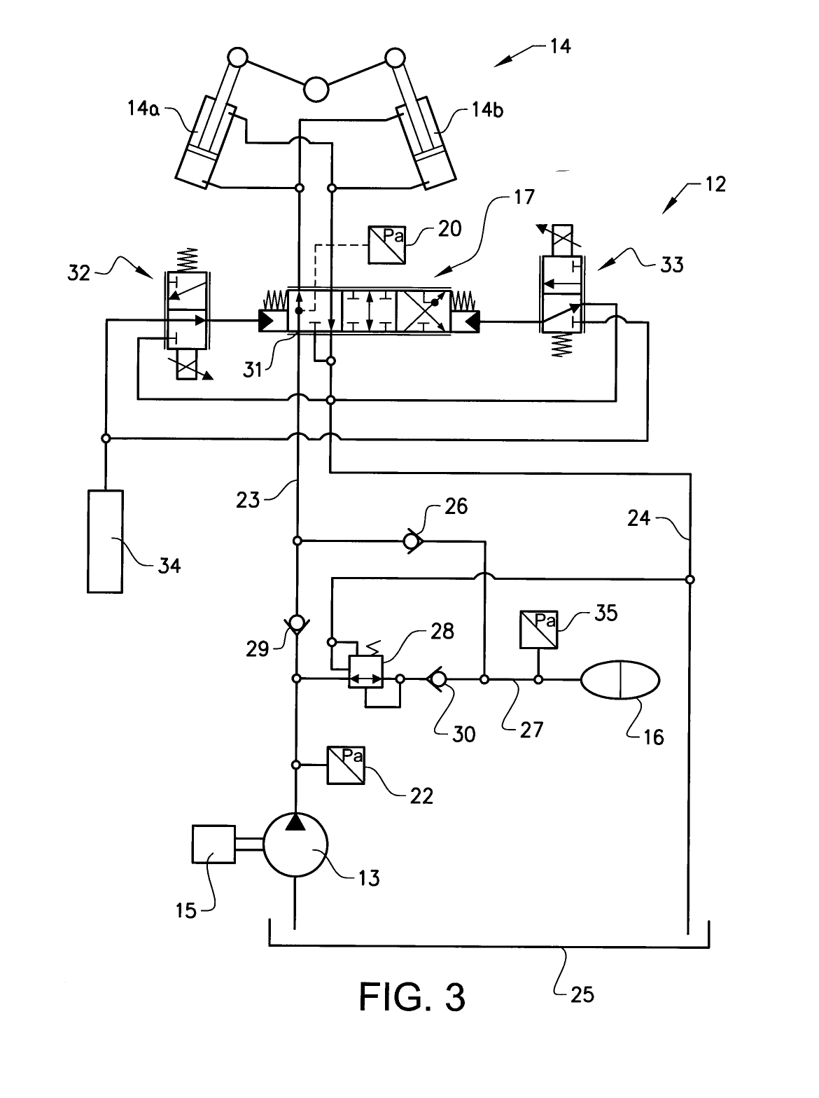

In FIG. 3 a further embodiment of the hydraulic load sensing system according to the invention is shown. In this embodiment the actuator 14 has two hydraulic cylinders 14a, 14b arranged for providing an articulated frame eering mechanism of the working machine 1. The invention is especially useful in this application where it is important to get a quick response when there is a steering request from the operator. For the embodiments of the hydraulic system according to the invention described with reference to FIG. 3, only features and functions unique for these embodiments will be described in detail. Same reference numerals used in FIG. 3 as in FIG. 2 will indicate same or similar components as already described with reference to FIG. 2, and hereinafter these components will only be briefly described or not described at all.

Particularly, the main control unit 18 connected to some kind of operator input means, such as an operator lever 19 and the electric machine control unit 21, described with reference to FIG. 2 but not illustrated in FIG. 3, can also be applied correspondingly in the embodiment illustrated in FIG. 3.

The hydraulic cylinders 14a, 14b schematically illustrated in FIG. 3 can be mechanically connected to the working machine as described hereinabove for the steering cylinders 8, 9 with reference to FIG. 1 for obtaining the steering mechanism. The hydraulic cylinders 14a, 14b are preferably cross-coupled such that hydraulic fluid is provided to the piston side of one of the hydraulic cylinders at the same time as hydraulic fluid is provided to the piston rod side of the other hydraulic cylinder, and vice versa. Thereby both hydraulic cylinders 14a, 14b can be used for turning to the left as well as to the right.

In FIG. 3 a control valve or steering valve 17 is illustrated in detail, in addition to the steering valve 17 the hydraulic system comprises two pilot valves 32, 33 for controlling the steering valve 17, and a pressure source 34 used for providing a pilot pressure. By means of the pilot pressure the steering valve spool can be moved to the desired position for controlling the flow of hydraulic fluid through the steering valve 17.

In response to an operator steering request, a control unit controls the steering valve 17 and the steering valve is opened to provide hydraulic fluid from the pump 13 to the hydraulic steering cylinders 14a, 14b. The control unit send a signal to one of the pilot valves depending on the desired steering direction, in the example illustrated in FIG. 3 the control unit has sent a signal to the pilot valve 32 allowing a flow of pilot hydraulic fluid for movement of the steering valve spool to the right. In this spool position the steering valve 17 is opened for a flow of hydraulic, fluid through the steering valve 17 via the inlet port 31 and further to the hydraulic steering cylinders 14a, 14b. The hydraulic system further comprises a pressure sensor 20 for measuring the load pressure used for the LS-signal. This pressure sensor 20 can be arranged for measuring the pressure inside the steering valve 17.

As also previously described, when there is no load pressure in the actuator 14 or in other words; the pump 13 does not provide any hydraulic fluid or hydraulic fluid having a pressure below the pressure of the hydraulic accumulator 16, the accumulator 16 can provide a hydraulic fluid pressure for generating the LS-signal. The accumulator 16 can be connected to the same inlet port 31 of the steering valve 17 as the pump 13 enabling the pressure sensor 20 to measure an LS pressure generated by the accumulator fluid pressure. As soon as the control valve 17 be opened the fluid pressure from the accumulator 16 can be utilized. The pump 13 can then at least initially be controlled on the basis of the pressure generated by the hydraulic accumulator 16. By the LS-signal

generated by the pressure from the accumulator 16 the electric motor 15 and the pump 13 are activated and the pump 13 will provide a hydraulic fluid pressure corresponding to the LS pressure plus an offset.

Although the invention and the use of the hydraulic accumulator have been described in connection with a steering system where the steering valve is controlled by a pilot pressure and pilot valves as illustrated in FIG. 3, the invention can also be applied to a system having a steering valve that is controlled in any other suitable way. For example, there is often also an additional steering function where the operator can control the steering valve by means of a steering wheel and a steering column mechanically connected to the steering valve for movement of the steering valve spool, i.e. so called steering with orbitrol.

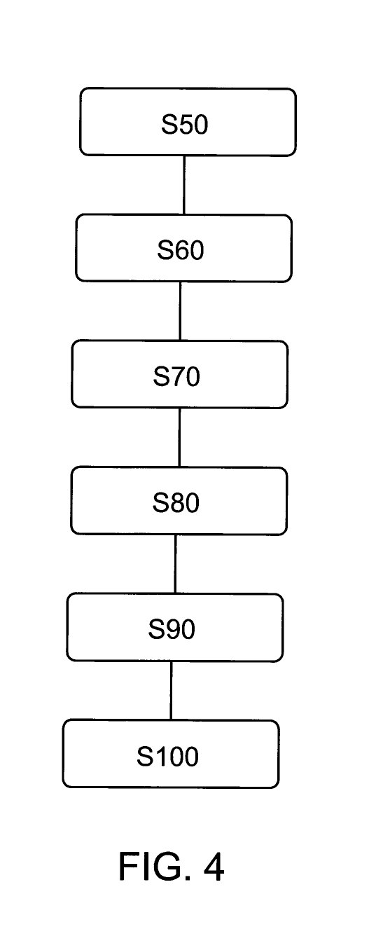

The invention also relates to a method for controlling a hydraulic load sensing system. Although the method will be described herein with reference to the flowchart in FIG. 4, the method may further implement any of the other features described hereinabove, particularly with reference to FIGS. 1, 2 and 3. For the components of the hydraulic system reference numerals associated with FIGS. 2 and 3 will be used. The method is applied to a hydraulic system comprising a pump 13 for providing hydraulic fluid for driving an actuator 14, and a hydraulic accumulator 16. The method comprises the step of providing a hydraulic fluid pressure by means of the hydraulic accumulator 16 for generating an LS-signal for controlling the hydraulic fluid pressure delivered by the pump 13.

In the example embodiment illustrated in FIG. 4, in a first step 550 an operator requests steering by means of an operator input means 19, thereby a signal from the operator input means is sent to a control unit 8. In a second step 560 the control unit receives the signal and sent a corresponding signal to a pilot valve 32 for controlling a steering valve 17. In a third step 870 the pilot valve 32 controls the flow of hydraulic fluid from a pilot pressure source 34 for obtaining the desired position of the spool of the steering valve 17. Hereby, the steering valve 17 be opened and a connection between the accumulator 16 and an LS pressure sensor is established via an inlet port 31 of the steering valve 17. In a further step S80 the US pressure sensor 20 measures the pressure created by the accumulator 16 and sends a corresponding signal to the control unit 18. In a further step S90 the control unit 18 receives the signal from the LS pressure sensor 20 and controls an electric motor 15 driving the pump 13 in accordance with the LS signal. This can be performed by means of an electric machine control unit 21 connected to the main control unit 18 which electric machine control unit 21 regulates the speed/torque of the electric motor 14. In next step S100, the pump pressure will be set to the measured LS pressure plus an offset by controlling the speed/torque of the electric motor 15. When the method is applied to the system illustrated in FIG. 3, the hydraulic cylinders 14a, 14b will start moving when the pressure in the supply line 23 is sufficiently high as compared to the external load of the hydraulic cylinders 14a, 14b. Depending on the load of the hydraulic cylinders 14a, 14b, this will occur immediately by means of the pressure created by the accumulator 16 or if this pressure is not sufficient, with somewhat delay by means of a higher pressure created by the pump 13. By using, the LS-signal created by the accumulator pressure for activating the pump 13 and starting provide hydraulic fluid to the actuator 14 by means of the pump 13, the delay time can however be kept relatively short even if the pump is not running when a steering operation is requested by an operator of the working machine.

It is to be understood that the present invention is not limited to the embodiments described above and illustrated in the drawings; rather, the skilled person will recognize that many changes and modifications may be made within the scope of the appended claims.

1. A hydraulic load sensing system (12) for a working machine (1), the hydraulic system comprising a pump (13) for providing hydraulic fluid for driving an actuator (14), and a hydraulic accumulator (16), characterized in that the hydraulic accumulator (16) is arranged to provide a hydraulic fluid pressure for generating an LS-signal for controlling the hydraulic fluid pressure delivered by the pump (13).

2. A hydraulic system according to claim 1, characterized in that the hydraulic system comprises a control valve (17) for controlling the actuator (14).

3. A hydraulic system according to claim 2, characterized in that the accumulator (16) is fluidly connected to the control valve (17) for providing the hydraulic fluid pressure.

4. A hydraulic system according to claim 2 or 3, characterized in that the pump (13) and the accumulator (16) are fluidly connected to the same inlet port (31) of the control valve (17).

5. A hydraulic system according to any preceding claim, characterized in that the hydraulic accumulator (16) is arranged to provide hydraulic fluid to the actuator (14) for driving the actuator.

6. A hydraulic system according to any preceding claim, characterized in that the hydraulic system comprises an electric motor (15) arranged for driving the pump (13).

7. A hydraulic system according to any preceding claim, characterized in that the hydraulic accumulator (16) is fluidly connected to the pump (13) for pressurizing the accumulator (16) when the pump (13) is driven.

8. A hydraulic system according to any preceding claim, characterized in that the hydraulic system comprises said actuator (14) being a steering mechanism of a working machine (1).

9. A hydraulic system according to claim 8, characterized in that the actuator (14) comprises two hydraulic cylinders (14a, 14b) arranged for providing an articulated frame steering mechanism.

10. A hydraulic system according to any preceding claim, characterized in that the pump (13) is of the type having a fixed displacement.

11. A method for controlling a hydraulic load sensing system (12), the hydraulic system comprising a pump (13) for providing hydraulic fluid for driving an actuator (14), and a hydraulic accumulator (16), characterized by providing a hydraulic fluid pressure by means of the hydraulic accumulator (16) for generating an LS-signal for controlling the hydraulic fluid pressure delivered by the pump (13).

12. A method according to claim 11, characterized by using the LS-signal generated by the accumulator pressure for activating the pump (13) and starting provide hydraulic fluid to the actuator (14) by means of the pump (13).

13. A method according to claim 12, characterized by activating the pump (13) and starting provide hydraulic fluid to the actuator (14) by means of the pump when a steering operation of a working machine (1) is requested by an operator of the working machine.

14. A method according to any of claims 11-13, characterized by using the LS-signal generated by the accumulator pressure for activating an electric motor (15) driving the pump (13).

15. A computer program comprising program code means for performing the steps of any of claims 11-14 when said program is run on a computer.

16. A computer readable medium comprising a computer program according to claim 15.

17. A control unit (18) for controlling a hydraulic system according to claim 1, the control unit being configured to perform the steps of the method according to any of claims 11-14.

18. A working machine comprising a hydraulic load sensing system according to any of claims 1-10.
